(19) United States
(12) Patent Application Publication
(10) Pub. No.: US 2007/0194896 A1
(43) Pub. Date: Aug. 23, 2007

(54) WIRELESS TIRE STATUS MONITOR AND MONITORING SYSTEM

(75) Inventors: Rodney P. Ehrlich, Monticello, IN (US); Paul D. Nelson, Martinsville, IN (US); Victor Vargas, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: WABASH NATIONAL, L.P., Lafayette, IN (US)

(21) Appl. No.: 11/468,327

(22) Filed: Aug. 30, 2006

Related U.S. Application Data
(60) Provisional application No. 60/774,567, filed on Feb. 17, 2006.

(51) Int. Cl. B60C 23/00

(52) U.S. Cl. 340/447

(57) ABSTRACT

A wireless tire pressure sensor which is configured to thread onto a valve of a tire and sense the air pressure of the tire. Preferably, the tire pressure sensor also includes a microcontroller and a transceiver, such that the tire pressure sensor can send as well as receive and process information. The tire pressure sensor is configured to maintain the tire pressure as a result of having a secondary valve thereon, which can be actuated to fill the tire with air. Also provided is a wireless tire status monitoring system which includes a wireless tire pressure transducer and/or tire pressure transducer. The transducer(s) are connected to a microcontroller which is powered by a battery. The microcontroller is connected to a transceiver which sends and receiver information using an antenna. The tire pressure and/or temperature information is communicated to a data concentrator which includes a transceiver which sends and receives information using an antenna and a processor which processes the data and effectively controls the system.

### RELATED APPLICATION (PRIORITY CLAIM)

This application claims the benefit of U.S. Provisional Application Ser. No. 60/774,567, which is hereby incorporated herein by reference in its entirety.

### BACKGROUND

The present invention generally relates to tire pressure sensors, and more specifically relates to a wireless tire status (such as pressure and/or temperature) monitor and monitoring system, which can be used, for example, in a mesh network for vehicles, such as tractor-trailers.

In order to improve the safety and economics of operating a commercial vehicle, tire pressure sensors are often used. One method of monitoring tire pressure is disclosed in U.S. Pat. No. 6,705,152. The pressure sensor disclosed in the '152 patent is wireless and includes a transmitter which is installed in a tire to wirelessly transmit the tire condition to a receiver which is installed on a dashboard of the vehicle. As such, tire pressure information is transmitted wirelessly from the tire pressure sensor to the dashboard, and the driver remains aware of tire pressure without having to physically exit the vehicle and manually check the tire pressure.

Because the transmitter of the sensor is powered by a battery, the transmitter stops operating when the battery becomes dead. In order to change the battery, the tire must be physically separated from the wheel. Because physically separating the tire from the wheel is not all that easy, this presents a problem. In addition, the pressure sensor assembly does not transport easily from tire to tire during normal maintenance and exchange of tire and wheel assembly.

Additionally, the sensor disclosed in the '152 patent is only capable of one-way communication, i.e., the wireless tire pressure sensor communicates information to a receiver, but cannot receive and process information. Also, the sensor continually transmits the information, mainly because the sensor has no way to determine whether the information has been actually received. This requirement of having to continually transmit information to the receiver has resulted in the batteries of the sensors, and the sensors themselves, having relatively short lives.

### OBJECT AND SUMMARY

An object of an embodiment of the present invention is to provide an improved system and method for monitoring the status of a tire on a vehicle, such as the tire's pressure and temperature.

Another object of an embodiment of the present invention is to provide a wireless tire pressure sensor which is mountable outside a tire, thereby providing that it is easily changed.

Another object of an embodiment of the present invention is to provide a wireless tire pressure sensor which is configured such that it need not continually transmit information, thereby prolonging the life of its battery and the sensor itself.

Briefly, an embodiment of the present invention provides a wireless tire pressure sensor which is configured to thread onto a valve of a tire and sense the air pressure of the tire. Preferably, the tire pressure sensor also includes a microcontroller and a transceiver, such that the tire pressure sensor can send as well as receive and process information. The tire pressure sensor is configured to maintain the tire pressure as a result of having a secondary valve thereon, which can be actuated to fill the tire with air.

Another embodiment of the present invention provides a wireless tire status monitoring system which includes a wireless tire pressure transducer and/or temperature transducer. The transducer(s) are connected to a microcontroller which is powered by a battery. The microcontroller is connected to a transceiver which sends and receiver information using an antenna. The tire pressure and/or temperature information is communicated to a data concentrator which includes a transceiver which sends and receives information using an antenna and a processor which processes the data and effectively controls the system.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 is a block diagram of a tire status monitoring system which is in accordance with an embodiment of the present invention;

FIG. 2 illustrates a wireless tire pressure sensor which is in accordance with an embodiment of the present invention;

FIG. 3 shows how the system associates a wireless sensor with the network;

FIG. 4 illustrates beacon communication;

FIG. 5 illustrates non-beacon communication;

FIG. 6 is a flow chart which shows how the wireless sensor goes into sleep mode to conserve its battery;

FIG. 7 shows how the wireless sensor relays information through an alternate node to provide that less power is required to transmit the information, thereby conserving its battery;

FIG. 8 illustrates the different layers of a vehicle network in which the sensor disclosed herein could be used;

FIG. 9 illustrates a mesh network architecture with which the sensor disclosed herein could be used; and

FIG. 10 illustrates an example of the mesh network architecture of FIG. 9, implemented on a tractor-trailer.

### DESCRIPTION

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

An embodiment of the present invention provides an improved system and method for monitoring the status of a tire on a vehicle, such as the tire's pressure and temperature. Within the system is a wireless tire pressure sensor which is mountable outside a tire, thereby providing easy access for service. The sensor is configured such that it need not continually transmit information, thereby prolonging the life of its battery and the sensor itself.

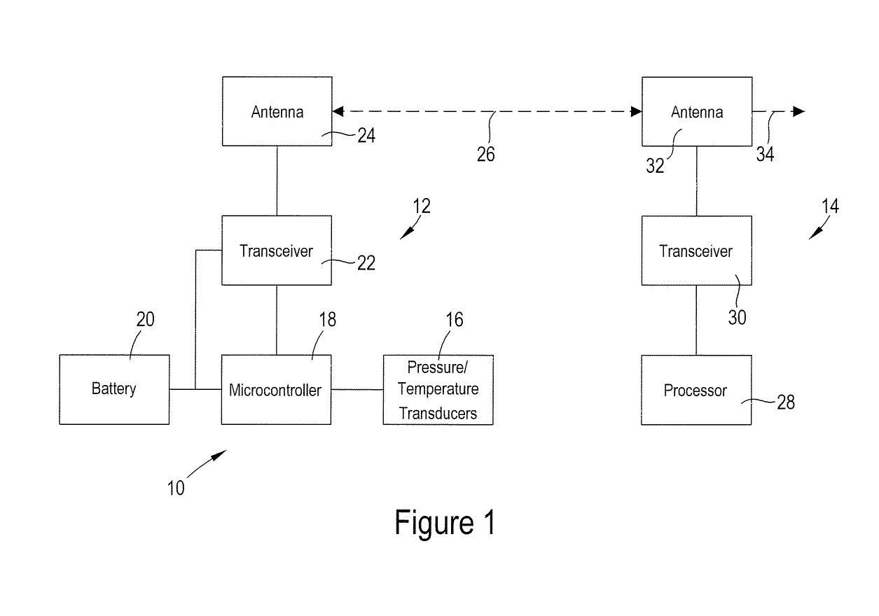

FIG. 1 illustrates a tire status monitoring system 10 which is in accordance with an embodiment of the present invention. The system 10 includes a tire pressure and/or temperature sensor 12 and a data concentrator 14. The sensor 12 includes pressure and/or temperature transducers 16 which are connected to a microcontroller or interrogator 18. The microcontroller 18 is powered by a battery 20, and is connected to a transceiver 22 which transmits and receives data using an antenna 24. The microcontroller 18 could be a Freescale HCS08 microcontroller, and the pressure transducer 16 could be a Freescale MPXY 8040 pressure transducer. The sensor 12 sends information to, and receives information from, the data concentrator 14 (as indicated by line 26 in FIG. 1). The microcontroller 18 of the sensor(s) 12 may be configured to inform the data concentrator 14 whenever a predetermined temperature and/or pressure has been reached.

The data concentrator 14 includes a processor 28 for processing data and controlling the overall system. The processor 28 is connected to a transceiver 30 which transmits and receives information using an antenna 32. Specifically, the transceiver 30 sends information to, and receives information from, the sensor 12 (as indicated by line 26 in FIG. 1) as well as possibly to and from another, remote site (as indicated by line 34 in FIG. 1). Specifically, the processor 28 may be configured to transmit raw or abstracted data to a management center that provides troubleshooting information, makes resource management decisions (such as preparing parts or labor resources to make a repair), and tracks problems in all or a subset of the commercial vehicles being managed. Preferably, for security reasons, all data that is communicated along lines 26 and 34 in FIG. 1 is encrypted.

Preferably, the processor 28 is configured such that the system 10 not only provides for monitoring, but also for the production of diagnostic and/or prognostic results. Preferably, the data concentrator 14 is configured to request that the sensed data be transmitted by the sensor(s) 12 at prompting by the data concentrator 14. The microcontroller 18 of the sensor(s) 12 may be configured such that, under certain operational conditions, the sensor(s) 12 alert the data concentrator 14 that a condition exists that might require immediate attention.

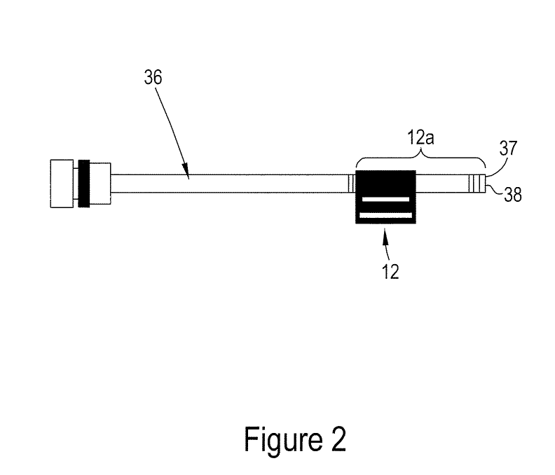

FIG. 2 illustrates a specific wireless tire pressure sensor assembly 12a which may be used in connection with the system 10 shown in FIG. 1. As shown in FIG. 2, the sensor assembly 12a is configured to threadably engage a standard valve stem 36 (i.e., the valve stem of a conventional tire) as well as have a threadable end 37 to attach extensions, a secondary valve, etc. When the sensor assembly 12a is threadably engaged as such, the sensor assembly 12a pushes in the pin of valve stem 36, thereby opening the valve. However, the sensor assembly 12a includes a secondary valve or pin 38 at its opposite end 37. As such, tire pressure is maintained, the sensor assembly 12a has access to the tire pressure, and the tire may be filled with air by engaging an air pump with the secondary valve 38, much like one would engage the air pump with the standard valve stem 36 when the sensor assembly 12a is not engaged therewith.

In addition to the secondary valve stem 38, the sensor assembly 12a includes the other components of the sensor 12 shown in FIG. 1 (hence the indication of reference numeral 12 in FIG. 2), namely a pressure transducer 16, a microcontroller 18, a battery 20, a transceiver 22 and an antenna 24. Additionally, although not specifically shown in FIG. 2, a bracket may be provided to secure the sensor assembly 12a, for anti-theft purposes.

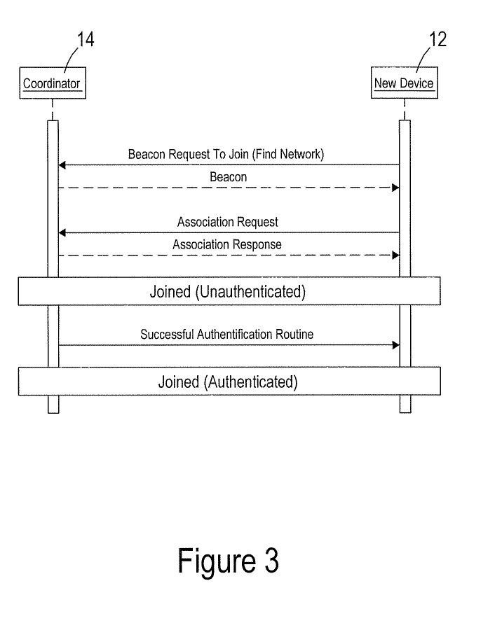

Preferably, the microcontroller 18 of the sensor 12 and the processor 28 of the data concentrator 14 are configured such that the wireless sensor 12 (and sensor assembly 12a) can automatically associate itself with the data concentrator 14, as shown in FIG. 3.

Due to the sensor assembly 12a being mounted on the valve stem 36 of the tire rather than on the wheel and inside the tire, the sensor 12 is easily serviced/replaced in the event of malfunction. Additionally, because the sensor assembly 12a mounts on the valve stem 36, the sensor assembly 12a is very easy to move from one tire or wheel assembly to another.

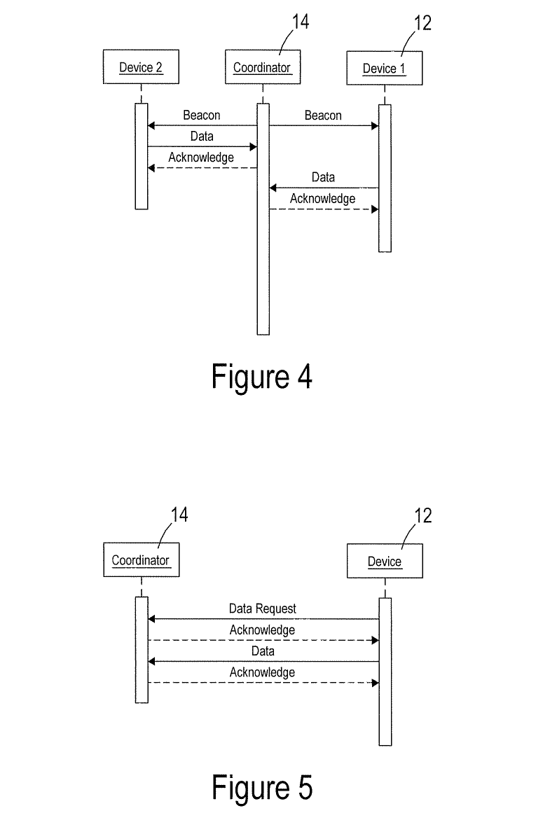

Communication of information from the sensor 12 to the data concentrator 14 shown in FIG. 1 can be performed either as a beacon-type communication or as a non-beacon type communication. Beacon mode is illustrated in FIG. 4 and offers maximum power savings because the data concentrator 14 need not be continuously waiting for communication from the sensor 12. In beacon mode, the sensor 12 effectively “watches out” for the data concentrator's 14 beacon when transmitted, locks on and looks for messages addressed to it. If message transmission is complete, the data concentrator 14 dictates a schedule for the next beacon so that the sensor 12 effectively “goes to sleep” with regard to information transmission. The data concentrator 14 may also switch to sleep mode.

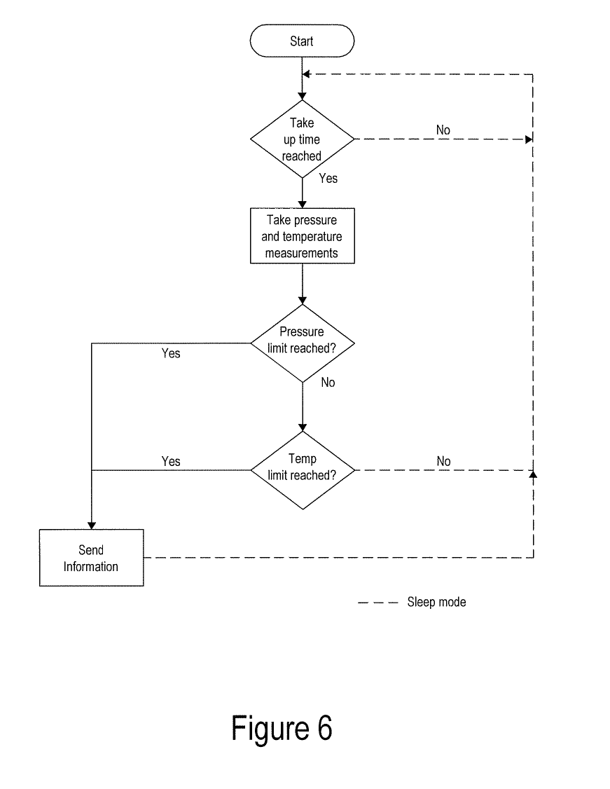

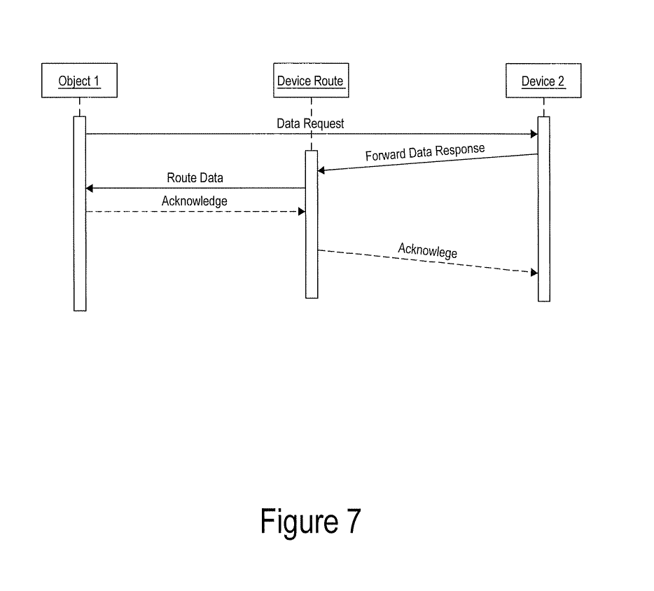

In non-beacon mode, as shown in FIG. 5, the sensor 12 wakes up and confirms its continued presence in the network at random intervals. On detection of activity, the sensor 12 ‘springs to attention’, as it were, and transmits to the ever-waiting data concentrator's transceiver 30. If the sensor 12 finds the channel busy, the acknowledgement allows for retry until success. As shown in FIG. 6, the sensor(s) 12 can be configured to send information based on events to the data concentrator 14. Additionally, as shown in FIG. 7, the sensor(s) 12 can be configured to relay information through an alternate node that will allow lower transmit power and conserve battery drain.

Other functionality which could be provided may include, but may not be limited to: the sensor 12 and/or data concentrator 14 being able to determine the leak rate of the tire, determine the condition of the battery 20 of the sensor 12. The microcontroller 18 can be configured such that it effectively maintains a gage in memory in order to keep track of how much the sensor 12 has used its battery so the sensor 12 could alert the data concentrator 14 when the battery power reaches a pre-determined level. The processor 28 of the data concentrator 14 can be configured such that it can determine, based on information received from the wireless sensor(s) 12, the remaining time until critical minimum tire pressure will be reached. Additionally, the microcontroller 18 can be configured to send an alert message to the data concentrator 14, indicating dangerous situations that could be developing on the tire. Upon recognizing a dangerous condition, the processor 28 of the data concentrator 14 can send a message to the driver of the vehicle, such as via an indication on the dashboard and/or the trailer corner post light communicator.

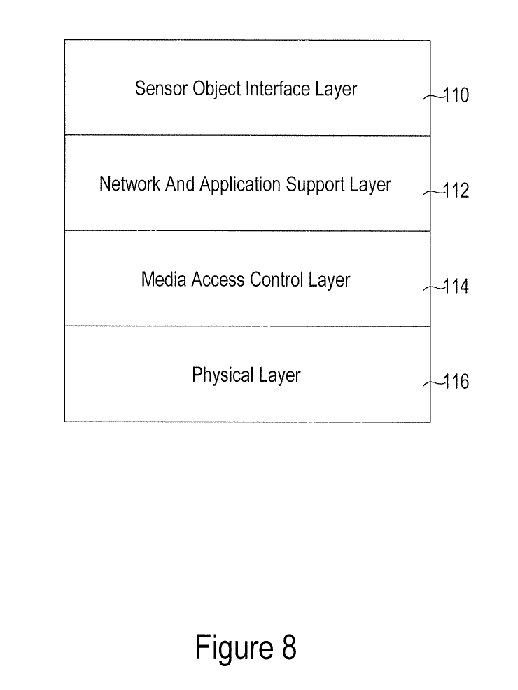

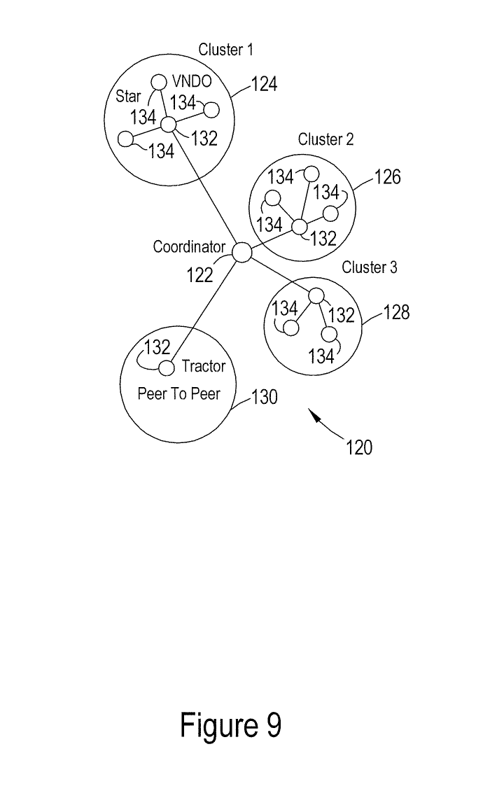

FIG. 8 illustrates the different layers of a wireless mesh network with which the system 10 shown in FIG. 1 can be used. As shown in FIG. 8, the layers include a Sensor Object Interface Layer 110, a Network and Application Support Layer (NWK) 112, a Media Access Control (MAC) Layer 114, and a Physical Layer 116. The NWK layer 112 is configured to permit growth of the network without having to use high power transmitters, and is configured to handle a huge number of nodes. The NWK layer 112 provides the routing and multi-hop capability required to turn MAC level 114 communications into a mesh network. For end devices, this amounts to little more than joining and leaving the network. Routers also have to be able to forward messages, discover neighboring devices and build up a map of the routes to other nodes. In the coordinator (identified with reference numeral 122 in FIG. 9), the NWK layer 112 can start a new network and assign network addresses to new devices when they join the network for the first time. This level in the vehicle network architecture includes the Vehicle Network Device Object (VNDO) (identified in FIG. 9), user-defined application profile(s) and the Application Support (APS) sub-layer, wherein the APS sub-layer's responsibilities include maintenance of tables that enable matching between two devices and communication among them, and also discovery, the aspect that identifies other devices that operate in the operating space of any device.

The responsibility of determining the nature of the device (Coordinator or Full Function Sensor) in the network, commencing and replying to binding requests and ensuring a secure relationship between devices rests with the VNDO. The VNDO is responsible for overall device management, and security keys and policies. One may make calls to the VNDO in order to discover other devices on the network and the services they offer, to manage binding and to specify security and network settings. The user-defined application refers to the end device that conforms architecture (i.e., an application is the software at an end point which achieves what the device is designed to do).

The Physical Layer 116 shown in FIG. 8 is configured to accommodate high levels of integration by using direct sequences to permit simplicity in the analog circuitry and enable cheaper implementations. The physical Layer 1 16 may be off the shelf hardware such as the Maxstream XBEE module, with appropriate software being used to control the hardware and perform all the tasks of the network as described below. The Media Access Control (MAC) layer 114 is configured to permit the use of several topologies without introducing complexity and is meant to work with a large number of devices. The MAC layer 114 provides reliable communications between a node and its immediate neighbors. One of its main tasks, particularly on a shared channel, is to listen for when the channel is clear before transmitting. This is known as Carrier Sense Multiple Access-Collision Avoidance communication, or CSMA-CA. In addition, the MAC layer 114 can be configured to provide beacons and synchronization to improve communications efficiency. The MAC layer 114 also manages packing data into frames prior to transmission, and then unpacking received packets and checking them for errors.

There are three different vehicle network device types that operate on these layers, each of which has an addresses (preferably there is provided an option to enable shorter addresses in order to reduce packet size), and is configured to work in either of two addressing modes—star or peer-to-peer.

FIG. 8 designates the layers associated with the network, meaning the physical (hardware) and interfaced to the MAC that controls the actual performance of the network. FIG. 8 is a description of one “node” while FIG. 9 shows the topology of individual “nodes” and how they are tied together to form the network.

FIG. 9 illustrates a mesh network architecture with which the system shown in FIG. 1 can be used. As shown, the network 120 includes a coordinator 122, and a plurality of clusters 124, 126, 128, 130. Each cluster includes several devices 132, 134 such as sensors, each of which is assigned a unique address. One of the devices (identified with reference numeral 132) of each cluster is configured to receive information from the other devices in the cluster (identified with reference numeral 134), and transmit information to the coordinator 122. The coordinator 122 not only receives information about the network, but is configured to route the information to other networks (as represented by arrow 36 in FIG. 9). As will be described in more detail hereinbelow, the network 120 could be disposed on a tractor-trailer, wherein the devices 132, 134 comprise different sensors, such as pressure sensors, temperature sensors, voltage sensors and switch controls, all of which are located in areas relatively close to each other.

The mesh network architecture provides that the sensors, and the overall network, can effectively self-organize, without the need for human administration. Specifically, the Vehicle Network Device Object (VNDO) (identified in FIG. 9) is originally not associated with any network. At this time it will look for a network with which to join or associate. The coordinator 122 “hears” the request coming from the non-associated VNDO and if it is pertinent to its network will go through the process of binding the VNDO to the network group. Once this association happens, the VNDO learns about all the other VNDO's in the associated network so it can directly talk to them and route information through them. In the same process, the VNDO can disassociate itself from the network as in the case of a tractor (VNDO) leaving the trailer (Coordinator) and then associating itself to a new trailer. The VNDO is an embodiment of both hardware and software to affect the performance of the network. This includes how each element interacts with each other, messages passed, security within the network, etc.

As shown in FIG. 9, there is one, and only one, coordinator (identified with reference numeral 122) in each network to act as the router to other networks, and can be likened to the root of a (network) tree. It is configured to store information about the network. Each cluster includes a full function sensor (FFS) (identified with reference numeral 132) which is configured to function as an intermediary router, transmitting data to the coordinator 122 which it receives from other devices (identified with reference numeral 134). Preferably, each FFS is configured to operate in all topologies and is configured to effectively act as a coordinator for that particular cluster.

The architecture shown in FIG. 9 is configured to provide low power consumption, with battery life ranging from a month to many years. In the vehicle network, longer battery life is achievable by only being used when a requested operation takes place. The architecture also provides high throughput and low latency for low duty-cycle applications, channel access using Carrier Sense Multiple Access with Collision Avoidance (CSMA-CA), addressing space for over 65000 address devices, a typical range of 1100 m, a fully reliable “hand-shaked” data transfer protocol, and different topologies as illustrated in FIG. 9, i.e., star, peer-to-peer, mesh.

The mesh network architecture shown in FIG. 9 has the ability to be able to enhance power saving, thus extending the life of the module based on battery capacity. The architecture is configured to route the information through nodes 132, 134 in the network and also has the ability to reduce the power needed to transmit information. Specifically, natural battery life extension exists as a result of passing information through nodes that are in close proximity to each other.

The sensors 132, 134 in the network are configured such that they are able to go into sleep mode—a mode of operation that draws an extremely low amount of battery current. Each sensor 132, 134 may be configured such that it periodically wakes, performs its intended task and if the situation is normal, returns to its sleep mode. This manner of operation greatly extends the life of the unit by not continually transmitting information, which in a typical vehicle network is the greatest drain on the battery capacity. While in sleep mode, the gateway device 132 requests information from the other devices 134 in the cluster. Acting on this request, the devices 134 wake up, perform the intended task, send the requested information to the gateway device 132, and return to sleep mode.

The vehicle network may be configured to addresses three different data traffic protocols:
1. Data is periodic. The application dictates the rate, and the sensor activates, checks for data and deactivates. The periodic sampling data model is characterized by the acquisition of sensor data from a number of remote sensor nodes and the forwarding of this data to the gateway on a periodic basis. The sampling period depends mainly on how fast the condition or process varies and what intrinsic characteristics need to be captured. This data model is appropriate for applications where certain conditions or processes need to be monitored constantly. There are a couple of important design considerations associated with the periodic sampling data model. Sometimes the dynamics of the monitored condition or process can slow down or speed up; if the sensor node can adapt its sampling rates to the changing dynamics of the condition or process, over-sampling can be minimized and power efficiency of the overall network system can be further improved. Another critical design issue is the phase relation among multiple sensor nodes. If two sensor nodes operate with identical or similar sampling rates, collisions between packets from the two nodes are likely to happen repeatedly. It is essential for sensor nodes to be able to detect this repeated collision and introduce a phase shift between the two transmission sequences in order to avoid further collisions.
2. Data is intermittent (event driven). The application, or other stimulus, determines the rate, as in the case of door sensors. The device needs to connect to the network only when communication is necessitated. This type of data communication enables optimum saving on energy. The event-driven data model sends the sensor data to the gateway based on the happening of a specific event or condition. To support event-driven operations with adequate power efficiency and speed of response, the sensor node must be designed such that its power consumption is minimal in the absence of any triggering event, and the wake-up time is relatively short when the specific event or condition occurs. Many applications require a combination of event-driven data collection and periodic sampling.
3. Data is repetitive (store and forward), and the rate is fixed a priori. Depending on allotted time slots, devices operate for fixed durations. With the store-and-forward data model, the sensor node collects data samples and stores that information locally on the node until the transmission of all captured data is initiated. One example of a store-and-forward application is where the temperature in a freight container is periodically captured and stored; when the shipment is received, the temperature readings from the trip are downloaded and viewed to ensure that the temperature and humidity stayed within the desired range. Instead of immediately transmitting every data unit as it is acquired, aggregating and processing data by remote sensor nodes can potentially improve overall network performance in both power consumption and bandwidth efficiency.

Two different bi-directional data communication models which may be utilized in connection with the present invention are polling and on-demand.

With the polling data model, a request for data is sent from the coordinator via the gateway to the sensor nodes which, in turn, send the data back to the coordinator. Polling requires an initial device discovery process that associates a device address with each physical device in the network. The controller (i.e., coordinator) then polls each wireless device on the network successively, typically by sending a serial query message and retrying as needed to ensure a valid response. Upon receiving the query's answer, the controller performs its pre-programmed command/control actions based on the response data and then polls the next wireless device.

The on-demand data model supports highly mobile nodes in the network where a gateway device is directed to enter a particular network, binds to that network and gathers data, then un-binds from that network. An example of an application using the on-demand data model is a tractor that connects to a trailer and binds the network between that tractor and trailer, which is accomplished by means of a gateway. When the tractor and trailer connect, association takes place and information is exchanged of information both of a data plate and vital sensor data. Now the tractor disconnects the trailer and connects to another trailer which then binds the network between the tractor and new trailer. With this model, one mobile gateway can bind to and un-bind from multiple networks, and multiple mobile gateways can bind to a given network. The on-demand data model is also used when binding takes place from a remote situation such as if a remote terminal was to bind with a trailer to evaluate the state of health of that trailer or if remote access via cellular or satellite interface initiates such a request.

Referring to FIG. 9, the functions of the coordinator 122, which usually remains in the receptive mode, encompass network set-up, beacon transmission, node management, storage of node information and message routing between nodes. The network nodes, however, are meant to save energy (and so ‘sleep’ for long periods) and their functions include searching for network availability, data transfer, checking for pending data and querying for data from the coordinator.

Comparing FIG. 1 to FIG. 9, the data concentrator 14 of FIG. 1 can be used as the coordinator 122 of FIG. 9, and the sensor 12 of FIG. 1 (and hence also the sensor assembly 12a of FIG. 2) can be used for at least some of the devices 132, 134 of FIG. 9.

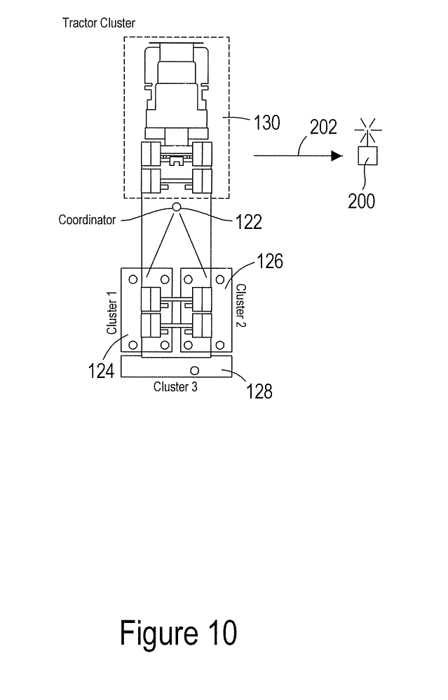

FIG. 10 illustrates an arrangement which is possible on a tractor-trailer. For the sake of simplicity without jeopardizing robustness, this particular architecture defines a quartet frame structure and a super-frame structure used optionally only by the coordinator. The four frame structures are: a beacon frame for the transmission of beacons; a data frame for all data transfers; an acknowledgement frame for successful frame receipt confirmations; and a MAC command frame.

These frame structures and the coordinator's super-frame structure play critical roles in security of data and integrity in transmission. The coordinator lays down the format for the super-frame for sending beacons. The interval is determined a priori and the coordinator thus enables time slots of identical width between beacons so that channel access is contention-less. Within each time slot, access is contention-based. Nonetheless, the coordinator provides as many guaranteed time slots as needed for every beacon interval to ensure better quality.

With the vehicle network designed to enable two-way communications, not only will the driver be able to monitor and keep track of the status of his vehicle, but also feed it to a computer system for data analysis, prognostics, and other management features for the fleets. As described above, the wireless sensor can be configured to communicate wirelessly via point-to-point wireless communication on a tractor-trailer, and/or in a wireless vehicle mesh network, for example. Such systems are described in other applications owned by the same assignee of the present application. For example, such systems are described in: U.S. Provisional Application Ser. No. 60/707,487, filed Aug. 11, 2005; U.S. Provisional Application Ser. No. 60/774,754, filed Feb. 17, 2006; and U.S. patent application Ser. No. 11/463,096, filed Aug. 8, 2006. Each of these applications is hereby incorporated herein by reference in their entirety.

As shown in FIG. 10, the vehicle network may be configured such that it can be queried wirelessly by a device 200, such as a hand held device or a mounted device, such that the vehicle network transmits information 202 about all of the tires (such as tire pressure information) on the tractor-trailer to the device 200.

While embodiments of the invention are shown and described, it is envisioned that those skilled in the art may devise various modifications without departing from the spirit and scope of the foregoing description.

What is claimed is:

1. A wireless tire status sensor configured to thread onto a valve of a tire and sense at least one of temperature and pressure of air in the tire, said wireless tire pressure sensor comprising: an end configured to thread onto the valve of the tire; and means for communicating information wirelessly.

2. A wireless tire status sensor as recited in claim 1, wherein said means for communicating information wirelessly comprises a transducer.

3. A wireless tire status sensor as recited in claim 2, wherein the transducer comprises a pressure transducer.

4. A wireless tire status sensor as recited in claim 2, wherein the transducer comprises a temperature transducer.

5. A wireless tire status sensor as recited in claim 1, wherein said means for communicating information wirelessly comprises a microcontroller.

6. A wireless tire status sensor as recited in claim 1, wherein said means for communicating information wirelessly comprises a transceiver.

7. A wireless tire status sensor as recited in claim 1, wherein said means for communicating information wirelessly comprises an antenna.

8. A wireless tire status sensor as recited in claim 1, wherein said means for communicating information wirelessly comprises a transducer, a microcontroller, a transceiver and an antenna, wherein the transducer is in communication with the microcontroller, the microcontroller is in communication with the transceiver, and the transceiver is configured to communicate wirelessly using the antenna.

9. A wireless tire status sensor as recited in claim 1, wherein the wireless tire status sensor is configured to communicate that a pre-determined temperature and/or pressure has been reached.

10. A wireless tire status sensor as recited in claim 1, wherein the wireless tire status sensor is instructable to transmit information at pre-determined events.

11. A wireless tire status sensor as recited in claim 1, wherein the wireless tire status sensor is configured to link with a wireless network.

12. A wireless tire status sensor as recited in claim 1, wherein the wireless tire status sensor is configured to communicate via a beacon-type communication.

13. A wireless tire status sensor as recited in claim 1, wherein the wireless tire status sensor is configured to communicate via a non-beacon type communication.

14. A wireless tire status sensor as recited in claim 1, wherein the wireless tire status sensor is configured to communicate leak rate of the tire.

15. A wireless tire status sensor as recited in claim 8, further comprising a battery configured to power the microcontroller.

16. A wireless tire status sensor as recited in claim 15, wherein the wireless tire status sensor is configured to communicate information regarding the condition of the battery of the wireless tire status sensor.

17. A wireless tire status sensor as recited in claim 1, wherein the wireless tire status sensor is configured to communicate wirelessly via point-to-point wireless communication on a tractor-trailer.

18. A wireless tire status sensor as recited in claim 1, wherein the wireless tire status sensor is configured to communicate wirelessly in a wireless vehicle mesh network.

19. A wireless tire status sensor as recited in claim 1, wherein the wireless tire status sensor has a second end comprising a valve which is configured for engagement with an air pump.

20. A wireless tire status sensor as recited in claim 1, further comprising a threaded end.

21. A wireless tire status sensor as recited in claim 1, wherein the sensor is configured to be part of a tractor-trailer vehicle network which is configured to be wirelessly queried by a device to obtain information about all of the tires on the tractor-trailer.
